(19) United States
(12) Patent Application Publication
(10) Pub. No.: US 2025/0274882 A1
(43) Pub. Date: Aug. 28, 2025

(54) METHOD AND APPARATUS FOR SELECTING SYNCHRONIZATION REFERENCE SOURCE, STORAGE MEDIUM AND ELECTRONIC APPARATUS

(71) Applicant: ZTE CORPORATION, Shenzhen (CN)

(72) Inventors: Weimin XING, Shenzhen (CN); Youxiong LU, Shenzhen (CN); Jie CHEN, Shenzhen (CN)

(21) Appl. No.: 18/859,828

(22) PCT Filed: Apr. 7, 2023
(86) PCT No.: PCT/CN2023/087053

§ 371 Date: Oct. 24, 2024

(30) Foreign Application Priority Data
Apr. 24, 2022 (CN) 202210434750.4

(51) Int. Cl. H04W 56/00; H04W 72/56

(52) U.S. Cl. CPC H04W 56/001; H04W 72/56

(57) ABSTRACT

Provided are a method and an apparatus for selecting a synchronization reference source, a storage medium and an electronic apparatus. The method comprises: receiving a synchronization priority configured for an NR device or an NR module, such that the configured NR device or NR module selects a synchronization reference source by using a priority criterion of LTE.

### CROSS-REFERENCE TO RELATED APPLICATION

The present disclosure is a national stage filing of under 35 U.S.C. § 371 of international application number PCT/CN2023/087053, filed Apr. 7, 2023, which claims priority to Chinese patent application no. 202210434750.4, filed with the Chinese Patent Office on Apr. 24, 2022 and entitled “Method and Apparatus for Selecting Synchronization Reference Source, Storage Medium and Electronic Apparatus”, which is incorporated herein by reference in its entirety.

### TECHNICAL FIELD

The embodiments of the present disclosure relate to the field of communications, and in particular, to a method and an apparatus for selecting a synchronization reference source, a storage medium and an electronic apparatus.

### BACKGROUND

Direct communication may also be referred to as Sidelink (SL) communication. Currently, SL communication has two Radio Access Technologies (RAT), including: SL communication using 4G Long Term Evolution (LTE) technology; and SL communication using 5G New Radio (NR) technology. In the current SL communication process, the scenario where two RATs share the same carrier is not considered. Moreover, according to the latest discussion, there may not be enough carriers for different RATs, and therefore how to enable two or more RATs to share the same carrier becomes an urgent problem to be solved.

Generally, SL communications include unicast, multicast, and broadcast communications. Before communication, devices need to be synchronized because two adjacent devices selecting the same synchronization reference source facilitates communication between the devices. At present, Sidelink User Equipment (SL UE) selects an appropriate synchronization reference source according to a certain priority criterion, and the synchronization reference source is used for subsequent SL communication. Specifically, an SL UE using NR technology may select a synchronization reference or a synchronization reference source by using a priority criterion defined in protocol TS38.331. An SL UE using NR technology and an SL UE using LTE technology use different priority criteria. If the coexistence of LTE and NR is expected to be supported, a corresponding method must be considered to prevent two devices from using different synchronization reference sources. However, in the prior art, it cannot be ensured that an SL UE using NR technology and an SL UE using LTE technology use the same synchronization reference source.

Aiming at the problem in the prior art that it cannot be ensured that an SL device using NR technology and an SL device using LTE technology use the same synchronization reference source, no effective solution has been proposed.

Therefore, there is a need for improvements in the related art to overcome the defect in the related art.

### SUMMARY

The embodiments of the present disclosure provide a method and an apparatus for selecting a synchronization reference source, a storage medium and an electronic apparatus, so as to at least solve the problem in the prior art that it cannot be ensured that an SL device using NR technology and an SL device using LTE technology use the same synchronization reference source.

According to an embodiment of the present disclosure, a method for selecting a synchronization reference source is provided. The method comprises: a synchronization priority configured for an NR device or an NR module is received, such that the configured NR device or NR module selects a synchronization reference source by using a priority criterion of LTE.

According to an embodiment of the present disclosure, a method for selecting a synchronization reference source is provided. The method comprises: a synchronization priority configured for an NR device or an NR module is configured, such that the configured NR device or NR module selects a synchronization reference source by using a priority criterion of LTE.

According to an embodiment of the present disclosure, a method for selecting a synchronization reference source is provided. The method comprises: a first synchronization reference source of a carrier X is selected by means of a first communication module of an SL UE, and the first synchronization reference source is taken as a synchronization reference source of a second communication module, wherein the SL UE supports both the first communication module and the second communication module.

According to an embodiment of the present disclosure, an apparatus for selecting a synchronization reference source is provided. The apparatus comprises: a receiving module, configured to receive a synchronization priority configured for an NR device or an NR module, such that the configured NR device or NR module selects a synchronization reference source by using a priority criterion of LTE.

According to an embodiment of the present disclosure, an apparatus for selecting a synchronization reference source is provided. The apparatus comprises: a configuration module, configured to configure a synchronization priority configured for an NR device or an NR module, such that the configured NR device or NR module selects a synchronization reference source by using a priority criterion of LTE.

According to an embodiment of the present disclosure, an apparatus for selecting a synchronization reference source is provided. The apparatus comprises: a selection module, configured to select a first synchronization reference source of a carrier X by means of a first communication module of an SL UE, and take the first synchronization reference source as a synchronization reference source of a second communication module, wherein the SL UE supports both the first communication module and the second communication module.

By means of the present disclosure, a synchronization priority configured for an NR device or an NR module is received, such that the configured NR device or NR module selects a synchronization reference source by using a priority criterion of LTE. The priority criterion for the configured NR device or NR module selecting a synchronization reference source is consistent with the priority criterion of LTE, and therefore it can be ensured that the configured NR device or NR module use the same synchronization reference source as an LTE device.

### BRIEF DESCRIPTION OF THE DRAWINGS

FIG. 1 is a hardware structural block diagram of user equipment of an alternative method for selecting a synchronization reference source according to an embodiment of the present disclosure;

FIG. 2 is a flowchart of an alternative method for selecting a synchronization reference source according to an embodiment of the present disclosure;

FIG. 3 is another flowchart of an alternative method for selecting a synchronization reference source according to an embodiment of the present disclosure;

FIG. 4 is yet another flowchart of an alternative method for selecting a synchronization reference source according to an embodiment of the present disclosure;

FIG. 5 is a structural block diagram of an alternative apparatus for selecting a synchronization reference source according to an embodiment of the present disclosure;

FIG. 6 is another structural block diagram of an alternative apparatus for selecting a synchronization reference source according to an embodiment of the present disclosure;

FIG. 7 is yet another structural block diagram of an alternative apparatus for selecting a synchronization reference source according to an embodiment of the present disclosure.

### DETAILED DESCRIPTION OF THE EMBODIMENTS

In order to make persons skilled in the art better understand the solutions of the present disclosure, the following clearly and completely describes the technical solutions in the embodiments of the present disclosure with reference to the drawings in the embodiments of the present disclosure. Apparently, the described embodiments are merely some of rather than all of the embodiments of the present disclosure. All other embodiments obtained by a person of ordinary skill in the art based on the embodiments of the present disclosure without inventive efforts shall belong to the scope of protection of the present disclosure.

It should be noted that, terms such as “first” and “second” in the description and the claims of the present disclosure and the described drawings are used to distinguish similar objects, but are not necessarily used to describe a specific sequence or order. It should be understood that the data so used may be interchanged where appropriate such that the embodiments of the present disclosure described herein can be implemented in sequences other than those illustrated or described herein. In addition, the terms “comprise” and “have”, and any variations thereof, are intended to cover a non-exclusive inclusion, for example, a process, method, system, product, or apparatus that includes a series of steps or units is not necessarily limited to those steps or units that are expressly listed, but may include other steps or units that are not expressly listed or inherent to such process, method, product, or apparatus.

In order to better understand the following technical solutions, the technical terms in the present disclosure are explained as follows.

Synchronization reference and synchronization (reference) source: a general synchronization reference source is a source of synchronization reference, for example, a source of GNSS synchronization timing is a satellite system, which will be collectively referred to as a synchronization reference source hereinafter. It should be noted that the meanings of the two in the embodiments of the present disclosure are similar.

Synchronization reference type and synchronization priority configuration: it is generally used for indicating a synchronization source or a synchronization reference type with the highest priority, for example, it may be indicated as GNSS, base station (eNB and/or gNB), UE, etc., which will be collectively referred to as a synchronization priority in the embodiments of the present disclosure.

A 4G access network is also referred to as an Evolved UMTS Terrestrial Radio Access Network (EUTRA), wherein UMTS (Universal Mobile Telecommunications System) is a Universal Mobile Telecommunications System. The subsequent solutions of the embodiments of the present disclosure will not strictly distinguish names such as 4G, LTE and EUTRA.

Configuration and preconfiguration: a configuration is generally from a network or a base station, and is sent to a UE by means of signalling from the network or the base station, and a pre-configuration is generally a configuration provided by other high-level entities, such as a high-level of the UE itself and other network entities. The subsequent solutions of the embodiments of the present disclosure will not strictly distinguish between the configuration and the preconfiguration, and the following configuration also comprises the case of preconfiguration. In addition, the subsequent solutions of the embodiments of the present disclosure will refer to a base station, a network or other high-level entities as a high-level entity.

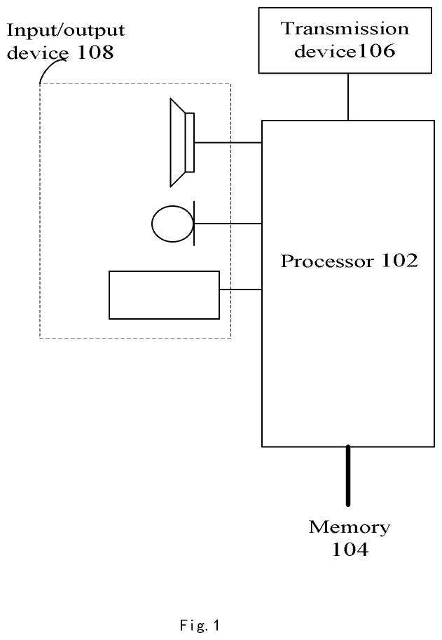

The method embodiments provided in the embodiments of the present disclosure may be implemented in user equipment or a similar computing apparatus. Taking running on user equipment as an example, FIG. 1 is a hardware structural block diagram of user equipment of a method for selecting a synchronization reference source according to an embodiment of the present disclosure. As shown in FIG. 1, user equipment may comprise one or more (only one is shown in FIG. 1) processors 102 (the processors 102 may include, but are not limited to, a processing apparatus such as a microprocessor MCU or a programmable logic device FPGA) and a memory 104 for storing data, wherein the user equipment may further comprise a transmission device 106 and an input/output device 108 for a communication function. A person of ordinary skill in the art may understand that the structure shown in FIG. 1 is merely exemplary, which does not limit the structure of the user equipment. For example, the user equipment may further comprise components more or less than that shown in FIG. 1, or have a configuration different from that shown in FIG. 1.

The memory 104 may be configured to store a computer program, for example, a software program and a module of application software, such as a computer program corresponding to the method for selecting a synchronization reference source in the embodiments of the present disclosure. The processor 102 runs the computer program stored in the memory 104, so as to execute various function applications and data processing, i.e. to implement the described method. The memory 104 may include a high-speed random access memory, and may also include a non-volatile memory, such as one or more magnetic storage apparatuses, flash memory, or other non-volatile solid-state memory. In some examples, the memory 104 may further include a memory configured remotely relative to the processor 102, and the remote memory may be connected to a mobile terminal over a network. Examples of the described network include, but are not limited to, the Internet, intranets, local area networks, mobile communication networks, and combinations thereof.

The transmission device 106 is configured to receive or transmit data via a network. Specific examples of the described network may include a wireless network provided by a communication provider of the mobile terminal. In an embodiment, the transmission device 106 includes a Network Interface Controller (NIC) that may be coupled to other network devices via a base station to communicate with the Internet. In an embodiment, the transmission device 106 may be a Radio Frequency (RF) module configured to wirelessly communicate with the Internet.

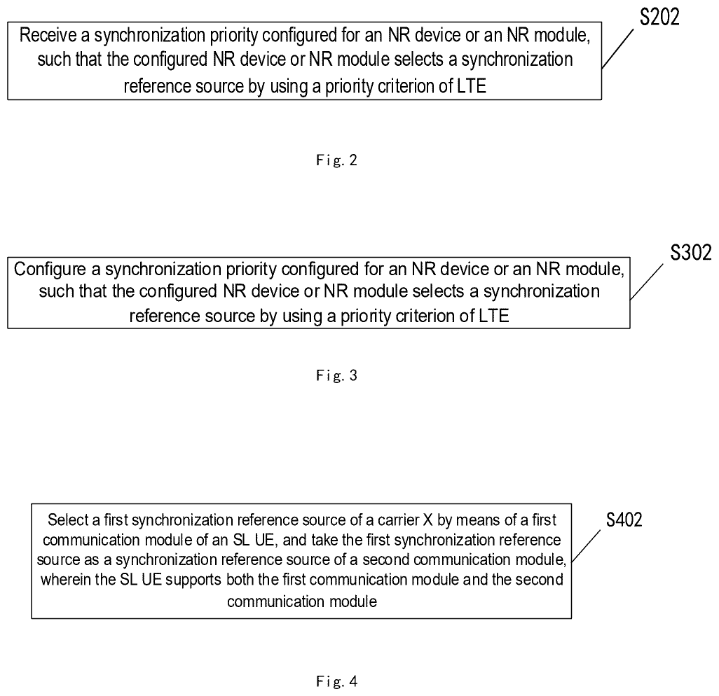

This embodiment provides a method for selecting a synchronization reference source running on the described user equipment. FIG. 2 is a flowchart of a method for selecting a synchronization reference source according to an embodiment of the present disclosure. As shown in FIG. 2, the flow comprises the following steps:

Step S202: a synchronization priority configured for an NR device or an NR module is received, such that the configured NR device or NR module selects a synchronization reference source by using a priority criterion of LTE.

By means of the described step, a synchronization priority configured for an NR device or an NR module is received, such that the configured NR device or NR module selects a synchronization reference source by using a priority criterion of LTE. The priority criterion for the configured NR device or NR module selecting a synchronization reference source is consistent with the priority criterion of LTE, and therefore it can be ensured that the configured NR device or NR module use the same synchronization reference source as an LTE device. Therefore, the problem in the prior art that it cannot be ensured that an SL device using NR technology and an SL device using LTE technology use the same synchronization reference source can be solved, thereby avoiding the interference caused by the non-synchronization of the LTE device and the NR device.

In an alternative embodiment, the method further comprises: a configured list of available carriers on which the NR device or NR module is allowed to work is received; for a carrier Y in the list of available carriers, it is received that the configured synchronization priority of the carrier Y comprises at least one of the following: GNSS-NR, GNSS-LTE, eNBgNB, eNB or UE.

In an alternative embodiment, the method further comprises: a configured list of available carriers on which the NR device or NR module is allowed to work is received; for a carrier Y in the list of available carriers, it is received that the configured synchronization priority of the carrier Y comprises one of the following: GNSS-NR, GNSS-LTE, eNBgNB, eNB or UE. In an alternative embodiment, the method further comprises: a configured list of available carriers on which the NR device or NR module is allowed to work is received; for a carrier Y in the list of available carriers, it is received that the configured synchronization priority of the carrier Y comprises one of the following: GNSS-NR, GNSS-LTE, eNBgNB and eNB.

In an alternative embodiment, the method further comprises: a configured list of available carriers on which the NR device or NR module is allowed to work is received; for a carrier Y in the list of available carriers, it is received that the configured synchronization priority of the carrier Y comprises one of the following: GNSS-NR, GNSS-LTE and eNBgNB.

In an alternative embodiment, the method further comprises: a configured list of available carriers on which an NR SL communication module is allowed to work is received; for a carrier Y in the list of available carriers, it is received whether the configured synchronization priority of the carrier Y is based on a priority criterion of LTE or NR, wherein the configured synchronization priority comprises: GNSS, base station or UE.

In an alternative embodiment, the method further comprises: different synchronization priority configurations correspond to different priority criteria. The method further comprises at least one of the following: GNSS-NR represents that GNSS is taken as a highest synchronization source, and dividing a priority set 1 of different synchronization reference sources according to a priority criterion defined by NR; GNSS-LTE represents that GNSS is taken as the highest synchronization source, and dividing a priority set 2 of different synchronization reference sources according to a priority criterion defined by LTE; eNBgNB represents that eNB or gNB is taken as the highest synchronization source, and dividing a priority set 3 of different synchronization reference sources according to the priority criterion defined by NR; eNB represents that eNB is taken as the highest synchronization source, and dividing a priority set 4 of different synchronization sources according to the priority criterion defined by LTE; UE represents that a timing of the UE is taken as the highest synchronization source; and selecting a synchronization reference source according to an order in the priority set of the detected synchronization reference sources. According to an embodiment of the present disclosure, a method for selecting a synchronization reference source is provided. The method comprises: a synchronization priority configured for an NR device or an NR module is configured, such that the configured NR device or NR module selects a synchronization reference source by using a priority criterion of LTE.

In the case of synchronization based on a Global Navigation Satellite System (GNSS), the priorities corresponding to different synchronization reference sources are as shown in the following table:

TABLE 1
Priorities corresponding to different synchronization
reference sources of SL UE using NR technology
in the case of GNSS-based synchronization
GNSS-based synchronization

PO: GNSS
Priority group 1: UE synchronized directly to GNSS
Priority group 2: UE synchronized indirectly to GNSS
Priority group 3: Base station (e.g., gNB, eNB, etc.)
Priority group 4: UE synchronized directly to base station
Priority group 5: UE synchronized indirectly to base station
Priority group 6: Other UEs

It should be noted that, for detailed definition of the Priority group, reference may be made to protocol TS38.331. Table 1 is a brief summary. P3 (Priority group 3) to P6 (Priority group 6) in Table 1 may be combined, that is, the synchronization reference sources corresponding to P3 to P6 in the following table are collectively referred to as P3. It should be further noted that the description in the foregoing table corresponds to the description in protocol TS38.331 on a one-to-one basis, for example, Priority group 1 (UE synchronized directly to GNSS) corresponds to Priority group 1 in the protocol (SLSSID=0, inCoverage=true or synchronization signals such as SLSS are transmitted on the allocated synchronization resource 3).

An SL UE using LTE technology may select a synchronization reference or a synchronization reference source by using a priority criterion defined in protocol TS36.331. For example, similarly in the case of synchronization based on a Global Navigation Satellite System (GNSS), the priorities corresponding to different synchronization reference sources are as shown in Table 2:

TABLE 2
Priorities corresponding to different synchronization
reference sources of SL UE using LTE technology
in the case of GNSS-based synchronization

| GNSS-within the coverage | |
|---|---|
| of base station | GNSS-out of the coverage of base station |
| P1: GNSS | P1: GNSS |
| P2: UE synchronized | P2: UE synchronized directly to GNSS, |
| directly to GNSS | or UE synchronized directly to eNB |
| P3: Base station (eNB) | P3: UE synchronized indirectly to GNSS, |
| | or UE synchronized indirectly to eNB |
| | P4: Other UEs |

It should be noted that, as shown in Table 1, GNSS-LTE represents that GNSS is taken as the highest synchronization source, and priority groups of different synchronization sources are divided according to a priority criterion defined by LTE, as shown in Table 2; eNBgNB represents that eNB or gNB base station is taken as the highest synchronization source, and priority groups of different synchronization sources are divided according to a priority criterion defined by NR, as shown in Table 3; eNB represents that eNB base station is taken as the highest synchronization source, and priority groups of different synchronization sources are divided according to the priority criterion defined by LTE, as shown in Table 4; UE represents that the UE's timing is taken as the highest synchronization source. The UE selects a synchronization reference according to the configured synchronization priority and the priority group order of the detected synchronization reference sources.

TABLE 3
Priorities corresponding to gNB/eNB synchronization sources
according to an embodiment of the present disclosure
gNB/eNB synchronization

P0: gNB/eNB
P1: UE synchronized directly to gNB/eNB
P2: UE synchronized indirectly to gNB/eNB
P3: GNSS
P4: UE synchronized directly to GNSS
P5: UE synchronized indirectly to GNSS
P6: Other UEs

TABLE 4
Priorities corresponding to eNB synchronization sources
according to an embodiment of the present disclosure
eNB synchronization

P0: eNB
P1: UE synchronized directly to eNB
P2: UE synchronized indirectly to eNB
P3: GNSS
P4: UE synchronized directly to GNSS
P5: UE synchronized indirectly to GNSS
P6: Other UEs

This embodiment provides a method for selecting a synchronization reference source running on a high-level entity such as a base station. FIG. 3 is another flowchart of a method for selecting a synchronization reference source according to an embodiment of the present disclosure. As shown in FIG. 3, the flow comprises the following steps:

Step S302: a synchronization priority configured for an NR device or an NR module is configured, such that the configured NR device or NR module selects a synchronization reference source by using a priority criterion of LTE.

By means of the described step, a synchronization priority configured for an NR device or an NR module is received, such that the configured NR device or NR module selects a synchronization reference source by using a priority criterion of LTE. The priority criterion for the configured NR device or NR module selecting a synchronization reference source is consistent with the priority criterion of LTE, and therefore it can be ensured that the configured NR device or NR module use the same synchronization reference source as an LTE device. Therefore, the problem in the prior art that it cannot be ensured that an SL device using NR technology and an SL device using LTE technology use the same synchronization reference source can be solved, thereby avoiding the interference caused by the non-synchronization of the LTE device and the NR device.

The entity for performing the described step may be a high-level entity such as a base station, but is not limited thereto.

In an alternative embodiment, the method further comprises: a list of available carriers on which an NR SL communication module is allowed to work is configured, and for a carrier Y in the list of available carriers, a synchronization priority of the carrier Y is configured to comprise at least one of the following: GNSS-NR, GNSS-LTE, eNBgNB, eNB or UE.

In an alternative embodiment, the method further comprises: a list of available carriers on which an NR SL communication module is allowed to work is configured, and for a carrier Y in the list of available carriers, whether the carrier Y is based on a priority criterion of LTE or NR is configured, wherein the configured synchronization priority comprises: GNSS, base station or UE.

This embodiment provides a method for selecting a synchronization reference source. FIG. 4 is yet another flowchart of a method for selecting a synchronization reference source according to an embodiment of the present disclosure. As shown in FIG. 4, the flow comprises the following steps:

Step S402: a first synchronization reference source of a carrier X is selected by means of a first communication module of an SL UE, and the first synchronization reference source is taken as a synchronization reference source of a second communication module, wherein the SL UE supports both the first communication module and the second communication module.

By means of the described step, a first synchronization reference source of a carrier X is selected by means of a first communication module of an SL UE, and the first synchronization reference source is taken as a synchronization reference source of a second communication module, wherein the SL UE supports both the first communication module and the second communication module. The priority criterion of the synchronization reference source of the first communication module and the second communication module is consistent with the priority criterion of LTE, and therefore it can be ensured that the synchronization reference source of the configured NR device or NR module is consistent. Therefore, the problem in the prior art that it cannot be ensured that an SL device using NR technology and an SL device using LTE technology use the same synchronization reference source can be solved, thereby avoiding the interference caused by the non-synchronization of the LTE device and the NR device.

It should be noted that, in addition to the first communication module used for NR SL communication, an SL UE further comprises a second communication module. The second communication module selects a first synchronization reference source of a carrier X, and the first synchronization reference source selected by the second communication module is taken as a synchronization reference source for the first communication module to perform communication. As there are two modules, i.e. an LTE module and an AR module, in the same device, there is no need to provide an enhancement module, and it is only necessary for the other module to process according to the synchronization reference source.

In an alternative embodiment, the method further comprises: configuration information of a list of available carriers is received by means of the second communication module; for a carrier Y in the list of available carriers, a first configuration of the first carrier Y is configured, wherein the first configuration is used for indicating whether the second communication module uses a synchronization reference source selected by the first communication module or uses a synchronization reference source selected by the second communication module; or the first configuration is used for indicating the second communication module to use the first synchronization reference source selected by the first communication module; or the first configuration is used for indicating to take the synchronization reference source selected by the second synchronization module as a main synchronization reference source or a synchronization reference source with the highest priority.

It should be noted that the described carrier Y may be the same as or different from the carrier X, which is not limited in the embodiments of the present disclosure.

In an alternative embodiment, the method further comprises: in a case where the first configuration is not configured, the second communication module uses a selected second synchronization reference source as the synchronization reference source.

In an alternative embodiment, the method further comprises: a second configuration is received by means of the first communication module, wherein the second configuration is used for indicating a priority criterion corresponding to a first module; and the priority criterion comprises: a synchronization priority configuration corresponding to the carrier X, and the priority configuration is used for determining a priority set corresponding to different synchronization reference sources on the carrier X.

In an alternative embodiment, the method further comprises: the priority criterion further comprises: a configuration of the list of available carriers.

In an alternative embodiment, the method further comprises: In the case where the first communication module selects a carrier Z and the carrier Z selects a third synchronization reference source, the first synchronization reference source of the carrier X is the third synchronization reference source selected by the carrier Z.

In an alternative embodiment, the method further comprises: the first communication module has a capability of making a synchronization reference selection according to a priority criterion defined by LTE.

It should be noted that, the first communication module has a capability of making a synchronization reference selection according to a priority criterion defined by LTE SL, and the first communication module may be an LTE SL communication module or a module dedicated to NR-LTE coexistence.

### Example 1

In this embodiment, an NR UE receives a configuration from a high-level entity, and a configured or preconfigured list of carriers on which an NR SL communication module is allowed to work is (CC1-CC5). Generally, the UE will select one carrier in this list of carriers to work. For a carrier Y in the list of carriers, a corresponding synchronization priority may be configured, and the synchronization priority comprises: GNSS-NR, GNSS-LTE, eNBgNB, eNB and UE. For example, for CC1, the synchronization priority may be configured as GNSS-LTE, then on CC1, the UE selects a synchronization reference source according to the priority group order defined by LTE, i.e. selects a synchronization reference source according to the order in Table 2.

In an embodiment, the UE receives a configuration from a high-level entity, and a configured or preconfigured list of carriers on which an NR SL communication module is allowed to work is (CC1-CC5). Generally, the UE will select one or more carriers in the list of carriers to work. For one carrier or all carriers in the list of carriers, a corresponding synchronization reference selection mode may be configured, and the synchronization reference selection mode comprises: LTE-based and NR-based. Further, for a carrier Y in the list of carriers, a corresponding synchronization priority may be configured, and the synchronization priority comprises: GNSS, base station and UE.

For example, for CC1, the synchronization reference selection mode may be configured as LTE-based, further the synchronization priority of CC1 is GNSS, then on CC1, the UE selects a synchronization reference according to the priority group order defined by LTE, i.e. selects a synchronization reference according to the order in Table 2.

### Example 2

In an embodiment, an NR UE receives a configuration from a high-level entity, and a configured or preconfigured list of carriers on which an NR SL communication module is allowed to work is (CC1-CC5). Generally, the UE will select one or more carriers in the list of carriers to work. For a carrier Y in the list of carriers, a corresponding synchronization priority may be configured, and the synchronization priority comprises: GNSS-NR, GNSS-LTE, eNBgNB, eNB and UE. Alternatively, for one carrier or all carriers in the list of carriers, a corresponding synchronization reference selection mode may be configured, and the synchronization reference selection mode comprises: LTE-based and NR-based. Further, for a carrier Y in the list of carriers, a corresponding synchronization priority may be configured, and the synchronization priority comprises: GNSS, base station and UE.

In addition, the NR UE may be configured with a synchronization reference carrier set, wherein the synchronization reference carrier set may be configured directly by a high-level entity, such as CC2-CC3; and the synchronization reference carrier set may also be determined indirectly, for example, all the synchronization reference selections are configured to use a carrier according to a criterion defined by LTE, and this carrier belongs to a synchronization reference carrier list.

If the NR UE selects a synchronization reference carrier, the UE takes a synchronization reference source on the synchronization reference carrier as a synchronization reference source on all the operating carriers. For example, the operating carriers of the UE are CC1 and CC2, wherein CC2 is the synchronization reference carrier selected by the UE. Assuming that the synchronization priority configuration of CC2 is GNSS-LTE, then on CC2, the UE selects a synchronization reference source a according to the priority group order defined by LTE, i.e. selects a synchronization reference a according to the order in Table 2. For CC1, the UE performs SL communication according to the synchronization reference source a on CC1 regardless of synchronization priority configuration. For another example, if only CC1 is the operating carrier of the UE, and the UE does not select a synchronization reference carrier, then the UE selects a synchronization reference source according to the priority group order determined by the synchronization priority configuration on CC1.

### Example 3

In an embodiment, UE1 is a dual-mode UE, comprising a first module (NR SL communication module) and a second module (LTE SL module or coexistence module, which will be referred to as an LTE module hereafter), and a configured or preconfigured list of carriers on which an NR SL communication module is allowed to work is (CC1-CC5). Generally, the first module will select one or more carriers in the list of carriers to work. Likewise, a configured or preconfigured list of carriers on which an LTE SL communication module is allowed to work is (CC2-CC6). It can be seen that a problem of coexistence between different devices may occur on CC2-CC5. Generally, one or more carriers in the list of carriers will be selected to work for SL communication. The configuration and selection of a synchronization reference source will be described below.

In an embodiment, a first configuration corresponding to a carrier is configured or preconfigured for the first module, indicating whether the carrier uses a synchronization reference source selected by the LTE SL communication module, for example, for a synchronization reference source selection of CC2, the LTE module selects a synchronization reference source according to a priority criterion of LTE, the operating carrier of the NR module is also on CC2 and the first configuration indicates to use a synchronization reference source selected by the LTE SL communication module, then the NR module also uses this synchronization reference source to perform SL communication. On the contrary, if for a carrier, it is indicated not to use or no indication is provided to use the synchronization reference source selected by the LTE SL communication module, the NR module selects a synchronization reference source by using a priority criterion defined by NR SL, and uses the synchronization reference to perform NR SL communication. For example, it is assumed that the operating carrier of NR SL is CC1, and there may be no first configuration on CC1 or the first configuration is configured to use the synchronization reference source selected by the LTE SL communication module.

### Example 4

In an embodiment, UE1 is a dual-mode UE, comprising a first module (NR SL communication module) and a second module (LTE SL module), and a configured or preconfigured list of carriers on which an NR SL communication module is allowed to work is (CC1-CC5). Generally, the first module will select one or more carriers in the list of carriers to work. It is assumed that final operating carriers of the first module are CC1 and CC2. Likewise, a configured or preconfigured list of carriers on which an LTE SL communication module is allowed to work is (CC2-CC6). Generally, the second module will select one or more carriers in the list of carriers to work. It is assumed that final operating carriers of the second module are CC2 and CC4. In an embodiment, the LTE module may be configured with a list of selection carriers of synchronization reference sources, such as CC3 and CC4. It can be seen that CC4 is a selection carrier of the synchronization reference source selected by the LTE module. In order to ensure that UE1 can use the same synchronization reference source to perform communication on all the carriers, synchronization may be performed by using the following method:

Assuming that the selection by the LTE module on CC4 is selection a of the synchronization reference source, then on CC2, the selection of the synchronization reference source used by the LTE module needs to be consistent with that on a reference carrier CC4, i.e. is also selection a of the synchronization reference source. If the NR module also works on CC2 and the first configuration indicates to use the selection of the synchronization reference source selected by the LTE SL communication module, the NR module also uses selection a of the synchronization reference source to perform SL communication. On CC1, the NR module also needs to use selection a of the synchronization reference source to perform SL communication. For example, only when the first configuration on CC1 also indicates to use the selection of the synchronization reference source selected by the LTE SL communication module, or the selection of the synchronization reference source selected by the NR module on CC1 is the same as selection a of the synchronization reference source, the NR module can use CC1.

### Example 5

A high-level entity needs to configure or preconfigure at least one of the following information for an SL UE:
a list of carriers available for an NR SL module or an NR SL UE, and a first configuration corresponding to each carrier in an explicit or implicit indication list are configured, wherein the first configuration is used for indicating whether to use the selection of a synchronization reference source selected by a second module on the carrier.

A list of available carriers corresponding to the second module, and a synchronization priority corresponding to a carrier X in the list are configured. Further, a selection list of synchronization reference sources corresponding to the second module may be configured.

### Example 6

In an embodiment, UE1 is a dual-mode UE, comprising a first module (NR SL communication module) and a second module, and a configured or preconfigured list of carriers on which an NR SL communication module is allowed to work is (CC1-CC5). Generally, the first module will select one or more carriers in the list of carriers to work. Likewise, a configured or preconfigured list of carriers on which an LTE SL communication module is allowed to work is (CC2-CC6). For the NR module, if one carrier meets the following conditions, the NR module may use the carrier:
selection a of a synchronization reference source selected by the second module on the carrier according to a priority criterion of LTE;
selection b of a synchronization reference source selected by the NR module on the carrier according to a priority criterion of NR; and
the selection a of the synchronization reference source is the same as the selection b of the synchronization reference source.

### Example 7

In an embodiment, UE1 is a dual-mode UE, comprising a first module (NR SL communication module) and a second module (LTE SL module). It is assumed that the operating carriers of the NR module are CC1 and CC2, and the operating carriers of the LTE module are CC2 and CC4. Generally, the NR SL module sends an NR SL transmission signal and an NR SL synchronization signal on the operating carriers, and the LTE SL module also sends an LTE SL transmission signal and an LTE SL synchronization signal on the operating carriers.

In order to solve the problem of collision between these signals, the practicable methods include but are not limited to:
if on one carrier, the NR module uses the selection of a synchronization reference source selected by the LTE SL communication module, the UE can only send an LTE SL synchronization signal on the carrier; and
if on one carrier, the NR module needs to send an NR SL transmission signal, and the LTE module needs to send or receive an LTE SL synchronization signal on the carrier; the sending of NR SL and the LTE SL synchronization signal are overlapped in a time domain, or resources in time and frequency domains are overlapped, then the UE only sends or receives the LTE SL synchronization signal;
if on one carrier, the NR module needs to send or receive an NR SL synchronization signal, and the LTE module needs to send or receive an LTE SL synchronization signal on the carrier; the NR SL synchronization signal and the LTE SL synchronization signal are overlapped in a time domain, or resources in time and frequency domains are overlapped, then the UE only sends or receives the LTE SL synchronization signal;
if on one carrier, the NR module needs to send or receive an NR SL synchronization signal, and the LTE module needs to send an LTE SL transmission signal on the carrier; the NR SL synchronization signal and the LTE SL signal are overlapped in a time domain, or resources in time and frequency domains are overlapped, then the UE only sends or receives the NR SL synchronization signal.

From the description of the described embodiments, a person skilled in the art may clearly understand that the methods according to the described embodiments may be implemented by software and a necessary universal hardware platform, and definitely may also be implemented by hardware. However, in many cases, the former is a preferred implementation. Based on such understanding, the technical solutions of the present disclosure essentially or the part contributing to the prior art may be embodied in the form of a software product. The computer software product is stored in a storage medium (such as a ROM/RAM, a magnetic disk, or an optical disk), and includes several instructions for causing a terminal device (which may be a mobile phone, a computer, a server, or a network device) to execute the methods described in the embodiments of the present disclosure.

This embodiment further provides an apparatus for selecting a synchronization reference source, which is used for implementing the described embodiments and preferred implementations, and what has been described will not be described herein again. The term “module”, as used hereinafter, is a combination of software and/or hardware capable of realizing a predetermined function. Although the apparatus described in the following embodiment is preferably implemented by software, implementation by hardware or a combination of software and hardware is also possible and conceived.

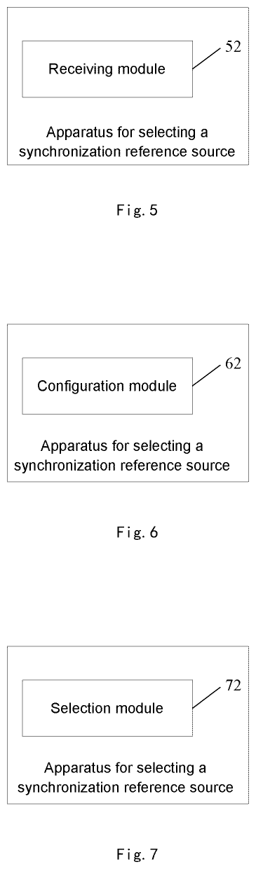

FIG. 5 is a structural block diagram of an alternative apparatus for selecting a synchronization reference source according to an embodiment of the present disclosure. As shown in FIG. 5, the apparatus comprises:
a receiving module 52, configured to receive a synchronization priority configured for an NR device or an NR module, such that the configured NR device or NR module selects a synchronization reference source by using a priority criterion of LTE.

By means of the described step, a synchronization priority configured for an NR device or an NR module is received, such that the configured NR device or NR module selects a synchronization reference source by using a priority criterion of LTE. The priority criterion for the configured NR device or NR module selecting a synchronization reference source is consistent with the priority criterion of LTE, and therefore it can be ensured that the configured NR device or NR module use the same synchronization reference source as an LTE device. Therefore, the problem in the prior art that it cannot be ensured that an SL device using NR technology and an SL device using LTE technology use the same synchronization reference source can be solved, thereby avoiding the interference caused by the non-synchronization of the LTE device and the NR device.

In an alternative embodiment, the receiving module 52 is further configured to receive a configured list of available carriers on which the NR device or NR module is allowed to work; for a carrier Y in the list of available carriers, it is received that the configured synchronization priority of the carrier Y comprises at least one of the following: GNSS-NR, GNSS-LTE, eNBgNB, eNB or UE.

In an alternative embodiment, the receiving module 52 is further configured to receive a configured list of available carriers on which an NR SL communication module is allowed to work; for a carrier Y in the list of available carriers, it is received whether the configured synchronization priority of the carrier Y is based on a priority criterion of LTE or NR, wherein the configured synchronization priority comprises: GNSS, base station or UE.

In an alternative embodiment, the receiving module 52 is further configured as different synchronization priority configurations correspond to different priority criteria, comprising: GNSS-NR represents that GNSS is taken as a highest synchronization source, and dividing a priority set 1 of different synchronization reference sources according to a priority criterion defined by NR; GNSS-LTE represents that GNSS is taken as the highest synchronization source, and dividing a priority set 2 of different synchronization reference sources according to a priority criterion defined by LTE; eNBgNB, also referred as gNBeNB, represents that eNB or gNB is taken as the highest synchronization source, and dividing a priority set 3 of different synchronization reference sources according to the priority criterion defined by NR; eNB represents that eNB is taken as the highest synchronization source, and dividing a priority set 4 of different synchronization sources according to the priority criterion defined by LTE; UE represents that a timing of the UE is taken as the highest synchronization source; and selecting a synchronization reference source according to an order in the priority set of the detected synchronization reference sources.

FIG. 6 is another structural block diagram of an alternative apparatus for selecting a synchronization reference source according to an embodiment of the present disclosure. As shown in FIG. 6, the apparatus comprises:
a configuration module 62, configured to configure a synchronization priority configured for an NR device or an NR module, such that the configured NR device or NR module selects a synchronization reference source by using a priority criterion of LTE.

By means of the described apparatus, a synchronization priority configured for an NR device or an NR module is received, such that the configured NR device or NR module selects a synchronization reference source by using a priority criterion of LTE. The priority criterion for the configured NR device or NR module selecting a synchronization reference source is consistent with the priority criterion of LTE, and therefore it can be ensured that the configured NR device or NR module use the same synchronization reference source as an LTE device. Therefore, the problem in the prior art that it cannot be ensured that an SL device using NR technology and an SL device using LTE technology use the same synchronization reference source can be solved, thereby avoiding the interference caused by the non-synchronization of the LTE device and the NR device.

In an alternative embodiment, the configuration module 62 is further configured to configure a list of available carriers on which an NR SL communication module is allowed to work, and for a carrier Y in the list of available carriers, configure a synchronization priority of the carrier Y to comprise at least one of the following: GNSS-NR, GNSS-LTE, eNBgNB, eNB or UE.

In an alternative embodiment, the configuration module 62 is further configured to configure a list of available carriers on which an NR SL communication module is allowed to work, and for a carrier Y in the list of available carriers, configure whether the carrier Y is based on a priority criterion of LTE or NR, wherein the configured synchronization priority comprises: GNSS, base station or UE.

FIG. 7 is yet another structural block diagram of an alternative apparatus for selecting a synchronization reference source according to an embodiment of the present disclosure. As shown in FIG. 7, the apparatus comprises:
a selection module 72, configured to select a first synchronization reference source of a carrier X by means of a first communication module of an SL UE, and take the first synchronization reference source as a synchronization reference source of a second communication module, wherein the SL UE supports both the first communication module and the second communication module.

In an alternative embodiment, the selection module 72 is further configured to receive configuration information of a list of available carriers by means of the second communication module; for a carrier Y in the list of available carriers, a first configuration of the first carrier Y is configured, wherein the first configuration is used for indicating whether the second communication module uses a synchronization reference source selected by the first communication module or uses a synchronization reference source selected by the second communication module; or the first configuration is used for indicating the second communication module to use the first synchronization reference source selected by the first communication module; or the first configuration is used for indicating to take the synchronization reference source selected by the second synchronization module as a main synchronization reference source or a synchronization reference source with the highest priority.

In an alternative embodiment, the selection module 72 is further configured as in a case where the first configuration is not configured, the second communication module uses a selected second synchronization reference source as the synchronization reference source.

In an alternative embodiment, the selection module 72 is further configured to receive a second configuration by means of the first communication module, wherein the second configuration is used for indicating a priority criterion corresponding to a first module; and the priority criterion comprises: a synchronization priority configuration corresponding to the carrier X, and the priority configuration is used for determining a priority set corresponding to different synchronization reference sources on the carrier X.

In an alternative embodiment, the priority criterion further comprises: a configuration of the list of available carriers.

In an alternative embodiment, the selection module 72 is further configured as if the first communication module selects a carrier Z and the carrier Z selects a third synchronization reference source, the first synchronization reference source of the carrier X is the third synchronization reference source selected by the carrier Z.

In an alternative embodiment, the first communication module has a capability of making a synchronization reference selection according to a priority criterion defined by LTE.

It should be noted that the described various modules may be implemented by software or hardware. The latter may be implemented in the following manner, but is not limited thereto: all the modules are located in a same processor; alternatively, the described various modules are located in different processors in an arbitrary combination.

The embodiments of the present disclosure further provide a non-transitory computer-readable storage medium, the computer-readable storage medium storing a computer program, wherein the computer program is configured to implement the steps in any one of the described method embodiments when executing.

In an exemplary embodiment, the non-transitory computer-readable storage medium may include, but is not limited to, any medium that can store a computer program, such as a USB flash disk, a Read-Only Memory (ROM), a Random Access Memory (RAM), a mobile hard disk, a magnetic disk, or an optical disk.

The embodiments of the present disclosure further provide an electronic apparatus, comprising a memory and a processor, wherein the memory stores a computer program, and the processor is configured to run the computer program so as to execute the steps in any of the described method embodiments.

In an exemplary embodiment, the electronic apparatus may further comprise a transmission device and an input/output device, wherein the transmission device is connected to the processor, and the input/output device is connected to the processor.

For specific examples in this embodiment, reference may be made to the examples described in the described embodiments and exemplary implementations, and details are not repeatedly described in this embodiment.

Obviously, those skilled in the art should understand that various modules or various steps in the embodiments of the present disclosure can be implemented by a universal computing apparatus, and the various modules or steps can be integrated on a single computing apparatus or distributed over a network formed by a plurality of computing apparatuses, and can be implemented by program codes executable by the computing apparatus, such that the modules or steps can be stored in a storage apparatus and executed by the computing apparatus, and the shown or described steps can be executed in sequences different from those described here in some cases, or the various modules or steps can be implemented by manufacturing the modules or steps into various integrated circuit modules respectively, or manufacturing multiple modules or steps among the various modules or steps into a single integrated circuit module. Thus, the present disclosure is not limited to any particular combination of hardware and software.

The foregoing descriptions are merely preferred embodiments of the present disclosure, and are not intended to limit the present disclosure. For those skilled in the art, the present disclosure may have various modifications and variations. Any modifications, equivalent replacements, improvements and the like made within the principle of the present disclosure shall belong to the scope of protection of the present disclosure.

1. A method for selecting a synchronization reference source, comprising:
receiving a synchronization priority configured for an NR device or an NR module, such that the configured NR device or NR module selects a synchronization reference source by using a priority criterion of LTE.

2. The method according to claim 1, wherein the method further comprises:
receiving a configured list of available carriers on which the NR device or NR module is allowed to work:
for a carrier Y in the list of available carriers, receiving the configured synchronization priority of the carrier Y, and the configured synchronization priority of the carrier Y comprises at least one of the following: GNSS-NR, GNSS-LTE, eNBgNB, eNB or UE.

3. The method according to claim 1, wherein the method further comprises:
receiving a configured list of available carriers on which an NR SL communication module is allowed to work;
for a carrier Y in the list of available carriers, receiving whether the configured synchronization priority of the carrier Y is based on a priority criterion of LTE or NR, wherein the configured synchronization priority comprises: GNSS, base station or UE.

4. The method according to claim 2, wherein different synchronization priority configurations correspond to different priority criteria, and the method further comprises at least one of the following: GNSS-NR represents that GNSS is taken as a highest synchronization source, and dividing a priority set 1 of different synchronization reference sources according to a priority criterion defined by NR: GNSS-LTE represents that GNSS is taken as the highest synchronization source, and dividing a priority set 2 of different synchronization reference sources according to a priority criterion defined by LTE: eNBgNB represents that eNB or gNB is taken as the highest synchronization source, and dividing a priority set 3 of different synchronization reference sources according to the priority criterion defined by NR: eNB represents that eNB is taken as the highest synchronization source, and dividing a priority set 4 of different synchronization sources according to the priority criterion defined by LTE: UE represents that a timing of the UE is taken as the highest synchronization source; and
selecting a synchronization reference source according to an order in the priority set of the detected synchronization reference sources.

5. A method for selecting a synchronization reference source, comprising:
configuring a synchronization priority configured for an NR device or an NR module, such that the configured NR device or NR module selects a synchronization reference source by using a priority criterion of LTE.

6. The method according to claim 5, wherein the method further comprises:
configuring a list of available carriers on which an NR SL communication module is allowed to work, and for a carrier Y in the list of available carriers, configuring a synchronization priority of the carrier Y to comprise at least one of the following: GNSS-NR, GNSS-LTE, eNBgNB, eNB or UE.

7. The method according to claim 5, wherein the method further comprises:
configuring a list of available carriers on which an NR SL communication module is allowed to work, and for a carrier Y in the list of available carriers, configuring whether the carrier Y is based on a priority criterion of LTE or NR, wherein the configured synchronization priority comprises: GNSS, base station or UE.

8. A method for selecting a synchronization reference source, comprising:
selecting a first synchronization reference source of a carrier X by means of a first communication module of an SL UE, and taking the first synchronization reference source as a synchronization reference source of a second communication module, wherein the SL UE supports both the first communication module and the second communication module.

9. The method according to claim 8, wherein the method further comprises:
receiving configuration information of a list of available carriers by means of the second communication module;
for a carrier Y in the list of available carriers, configuring a first configuration of the first carrier Y, wherein the first configuration is used for indicating whether the second communication module uses a synchronization reference source selected by the first communication module or uses a synchronization reference source selected by the second communication module: or the first configuration is used for indicating the second communication module to use the first synchronization reference source selected by the first communication module: or the first configuration is used for indicating to take the synchronization reference source selected by the second synchronization module as a main synchronization reference source or a synchronization reference source with the highest priority.

10. The method according to claim 9, wherein the method further comprises:
in a case where the first configuration is not configured, the second communication module uses a selected second synchronization reference source as the synchronization reference source.

11. The method according to claim 8, wherein the method further comprises:
receiving a second configuration by means of the first communication module, wherein the second configuration is used for indicating a priority criterion corresponding to a first module; and the priority criterion comprises: a synchronization priority configuration corresponding to the carrier X, and the priority configuration is used for determining a priority set corresponding to different synchronization reference sources on the carrier X.

12. The method according to claim 11, wherein the method further comprises:
the priority criterion further comprises: a configuration of the list of available carriers.

13. The method according to claim 11, wherein the method further comprises:
in a case where the first communication module selects a carrier Z and the carrier Z selects a third synchronization reference source, the first synchronization reference source of the carrier X is used as the third synchronization reference source selected by the carrier Z.

14. The method according to claim 8, wherein the method further comprises:
the first communication module has a capability of making a synchronization reference selection according to a priority criterion defined by LTE.

15. An apparatus for selecting a synchronization reference source, used for implementing the method as claimed in claim 1, and the apparatus comprises:
a receiving module, configured to receive a synchronization priority configured for an NR device or an NR module, such that the configured NR device or NR module selects a synchronization reference source by using a priority criterion of LTE.

16. An apparatus for selecting a synchronization reference source, used for implementing the method as claimed in claim 5, and the apparatus comprises:
a configuration module, configured to configure a synchronization priority configured for an NR device or an NR module, such that the configured NR device or NR module selects a synchronization reference source by using a priority criterion of LTE.

17. An apparatus for selecting a synchronization reference source, used for implementing the method as claimed in claim 8, and the apparatus comprises:
a selection module, configured to select a first synchronization reference source of a carrier X by means of a first communication module of an SL UE, and take the first synchronization reference source as a synchronization reference source of a second communication module, wherein the SL UE supports both the first communication module and the second communication module.

18. A non-transitory computer-readable storage medium, a computer program is stored in the computer-readable storage medium, wherein the computer program is configured to, when executed by a processor, implement execute the method according to claim 1.

19. An electronic apparatus, comprising a memory and a processor, wherein the memory stores a computer program, and the processor is configured to execute the computer program to implement the method according to claim 1.

20. An electronic apparatus, comprising a memory and a processor, wherein the memory stores a computer program, and the processor is configured to run the computer program so as to execute the method according to claim 5.
